(19) United States
(12) Patent Application Publication
(10) Pub. No.: US 2012/0248038 A1
(43) Pub. Date: Oct. 4, 2012

(54) ACID TOLUENE EXTRACTION OF DNT WASTEWATERS

(75) Inventors: Ruediger Fritz, Bernsdorf (DE); Renate Hempel, Ruhland (DE); Baerbel Guschel, Lauchhammer (DE); Helmut Richter, Thiendorf (DE); Anne-Kathrin Merten, Lauchhammer (DE); Michael Zoellinger, Eislingen (DE); Elvira Flegel, Bernsdorf (DE); Holger Allardt, Schwarzheide (DE); Reiner Reetz, Schwarzheide (DE)

(73) Assignee: BASF SE, Ludwigshafen (DE)

(21) Appl. No.: 13/516,280

(22) PCT Filed: Dec. 13, 2010
(86) PCT No.: PCT/EP2010/069548

§ 371 Date: Jun. 15, 2012

(30) Foreign Application Priority Data
Dec. 16, 2009 (EP) 09179501.3

(51) Int. Cl. C02F 1/26; C02F 1/04; C02F 1/66

(52) U.S. Cl. 210/639

(57) ABSTRACT

A process for working up alkaline process wastewater from the nitration of aromatic compounds to mono-, di- and trinitroaromatics with a pH of 7.5 to 13 or a mixture W with a pH of 6 to 10 of alkaline process wastewater and the aqueous distillate of the sulfuric acid concentration, comprising the steps of
a) acidifying the alkaline process wastewater or the mixture W by adding concentrated sulfuric acid which originates from the workup of the aqueous, sulfuric acid-containing phase obtained in the nitration to a pH below 2, which forms a mixture A consisting of organic phase which separates out and acidic aqueous phase, and
b) extracting the mixture A with an aromatic extractant.

The present invention relates to a process for working up alkaline process wastewater from the nitration of aromatic compounds, or a mixture W of alkaline process wastewater from the nitration and the aqueous distillate from the sulfuric acid concentration, wherein the alkaline process wastewater or the mixture is acidified by adding concentrated sulfuric acid which originates from the workup of the aqueous, sulfuric acid-containing phase obtained in the nitration, and the process wastewater or wastewater mixture thus acidified is extracted with an aromatic extractant.

Aromatic nitro compounds such as mono- and dinitrotoluene are typically prepared by nitrating the corresponding aromatic compounds by means of a mixture of concentrated nitric acid and concentrated sulfuric acid, which is referred to as nitrating acid. This forms an organic phase which comprises the crude product of the nitration, and an aqueous phase which comprises essentially sulfuric acid, water of reaction and water introduced by the nitrating acid. The nitric acid is consumed almost completely in the nitration.

After separation of the two phases, the aqueous, sulfuric acid-containing phase, according to the technology of the nitrating process, is mixed again with fresh nitric acid, directly or after concentration, and used for nitration. However, at least some of the sulfuric acid must be discharged continuously or batchwise from the overall process in order to avoid concentration of impurities, especially of metallic salts (see also DE 10 143 800 C1). The impurities are, for example, impurities originally present in the nitric acid, and metal compounds which are leached out of the reactor and pipe materials under the highly corrosive conditions which exist in the course of reaction and workup of the aqueous phase.

In the concentration of the aqueous, sulfuric acid-containing phase obtained in the nitration, an aqueous distillate with low sulfuric acid content, referred to hereinafter as aqueous distillate of the sulfuric acid concentration, and a phase with a high sulfuric acid content, referred to hereinafter as concentrated sulfuric acid, are obtained. The portion of the concentrated sulfuric acid discharged from the nitrating process is also referred to hereinafter as waste sulfuric acid.

The crude product of the nitration of aromatic compounds, such as benzene, toluene, xylene, chlorobenzene, etc, to the corresponding nitroaromatics typically comprises, as well as the desired nitroaromatics such as nitrobenzene (NB) and dinitrobenzene (DNB), mono- and dinitrotoluene (MNT and DNT), nitrochlorobenzene (NCB) or nitroxylene, also small amounts of mono-, di- and trinitrophenols (referred to hereinafter as nitrophenols), mono-, di- and trinitrocresols (referred to hereinafter as nitrocresols) and mono-, di- and trinitroxylenols (referred to hereinafter as nitroxylenols) and other compounds comprising hydroxyl groups and nitro groups, and also mono- and dinitrobenzoic acids (referred to hereinafter as nitrobenzoic acids).

Aromatic nitro compounds which do not comprise a hydroxyl group or carboxyl group in the molecule are also referred to in the context of the invention as neutral nitro species or neutral nitroaromatics. Nitrophenols, nitrocresols, nitroxylenols and nitrobenzoic acids are also summarized hereinafter as hydroxynitroaromatics.

The crude product from the nitration has to be freed from the undesired by-products before further use. Typically, the by-products, after removal of the nitrating acid, are removed by multistage scrubbing with acidic, alkaline and neutral scrubbing liquid, generally in the sequence stated. The alkaline scrubbing is typically performed with aqueous sodium hydroxide solution, aqueous sodium carbonate solution or aqueous ammonia solution. The alkaline process wastewater which arises comprises nitrophenols, nitrocresols, nitroxylenols and nitrobenzoic acids, in the form of their water-soluble salts of the base used. They are typically present in a concentration of 0.2 to 2.5% by weight, based on the alkaline process wastewater. The alkaline process wastewater also comprises neutral nitro species formed in the nitration, especially reaction products. Neutral nitro species are present in the alkaline process wastewater, typically in an amount of several 1000s of ppm. The alkaline process wastewater generally comprises 500 to 5000 ppm of nitrates, 500 to 5000 ppm of nitrite and several hundred ppm of sulfate. These ions originate from the nitration. The ingredients give rise to a chemical oxygen demand of 1000 to 20 000 mg/l.

The nitrophenols, nitrocresols, nitroxylenols, nitrobenzoic acids and in particular the salts thereof are intensely colored and highly toxic to the environment. Moreover, the nitrophenols and especially their salts, in relatively high concentrations or in substance, are explosives and have to be removed from the wastewater before the release thereof and disposed of in such a way that no risk to the environment emanates from them. The alkaline process wastewater also comprises neutral nitro species formed in the nitration, especially reaction products. Since the aromatic nitro compounds have bactericidal properties overall and hence make biological purification of the wastewater impossible, purification or workup of the wastewater comprising aromatic nitro compounds is necessary.

Numerous processes for removal of the nitrophenols, nitrocresols, nitroxylenols, nitrobenzoic acids and the neutral nitroaromatics from the process wastewaters are described in the literature, for example extraction, adsorption, oxidation or thermolysis.

The Encyclopedia of Chemical Technology, Kirk-Othmer, Fourth Edition 1996, Vol. 17, p. 138 discloses an extraction process for removing nitrobenzene, in which the nitrobenzene dissolved in the wastewater at the appropriate temperature is removed by extraction with benzene. Benzene which has dissolved in the water is removed by stripping before the final treatment of the wastewater.

According to U.S. Pat. No. 6,506,948, the wash phases obtained in the nitration of toluene are extracted directly with toluene, each of the wastewater streams which arise being extracted separately. The toluene stream is subsequently conducted into the nitration process and converted. This leaves nitrocresols and nitrobenzoic acids dissolved in the alkaline wastewater stream, which subsequently have to be removed separately.

The dissolved nitroaromatics and hydroxynitroaromatics can additionally be removed in an aqueous medium by extraction with an organic solvent (Ullmanns Enzyklopädie der technischen Chemie, 4^{th} edition, Volume 17, page 386).

The hydroxynitroaromatics present in the alkaline process wastewater can also be transferred by acidification to an organic phase which separates out and is subsequently removed. In order to prevent the crystallization of the hydroxynitroaromatics, the apparatus used for the separation and removal has to be heated. Nevertheless, the problem of “fouling” occurs. This means that the pumps and pipe systems used to remove the organic phase which separates out become blocked very rapidly by precipitating and crystallizing impurities, and there is therefore a high requirement for cleaning.

Such a process is described in EP 1 493 730 A1. In this process, the wastewater streams of the acidic and alkaline DNT scrubbings and from the sulfuric acid concentration are mixed, such that a pH below 5 is established. The wastewater from the sulfuric acid concentration is the distillate of the sulfuric acid concentration with a sulfuric acid concentration of 0.2 to 1% by weight. In the course of acidification, an organic phase separates out, which is removed. The aqueous phase is supplied separately to a further wastewater treatment.

In spite of the processes known to date for cleaning the alkaline process wastewaters obtained in the nitration of aromatics, there is a need for a process for recovering mono- and dinitrotoluene and simultaneously purifying the alkaline process wastewaters, in which the removal of the undesired neutral nitro species and of the hydroxynitroaromatics is achieved in a minimum number of process steps with a low material and energy input.

This object is achieved by the following process for working up alkaline process wastewater from the nitration of aromatic compounds to mono-, di- and trinitroaromatics with a pH of 7.5 to 13 or a mixture W with a pH of 6 to 10 of alkaline process wastewater and the aqueous distillate of the sulfuric acid concentration, comprising the steps of
a) acidifying the alkaline process wastewater or the mixture W by adding concentrated sulfuric acid which originates from the workup of the aqueous, sulfuric acid-containing phase obtained in the nitration to a pH below 2, which forms a mixture A consisting of organic phase which separates out and acidic aqueous phase, and
b) extracting the mixture A with an aromatic extractant.

The alkaline process wastewater treated by the process according to the invention is highly depleted of neutral nitro species, nitrocresols and nitrobenzoic acids, which are difficult to degrade, and also of nitrite.

A further advantage of the process according to the invention is that the sulfuric acid from the preparation process for the nitroaromatics, which is obtained in the concentration, can be used for the acidification of the alkaline process wastewater, especially since a proportion of the concentrated sulfuric acid must in any case be discharged from the circuit of nitration and sulfuric acid workup and disposed of as so-called waste sulfuric acid. The concentrated sulfuric acid comprises the salts obtained as a result of corrosion (pipelines) in the course of nitration, comprising Fe, Cr, Ni, Ta and traces of further heavy metals in the form of their sulfates. Typically, in the case of a rise in the salt concentration above 300 ppm, some of the acid has to be discharged from the process as so-called waste sulfuric acid and has to be disposed of or purified by other processes. The use of this waste sulfuric acid is therefore particularly advantageous, since the disposal or workup costs can be saved. It has been found that, surprisingly, the amount of concentrated sulfuric acid to be discharged can be used completely in the process according to the invention, without any further addition of additional sulfuric acid being required. This leads to very economic use of the different streams.

The use of the concentrated sulfuric acid additionally leads to the effect that, when the alkaline process wastewater is acidified, a large portion of the nitrite dissolved in the alkaline process wastewater is protonated to nitrous acid, which then separates into nitric acid and nitrogen oxides, and the nitrogen oxides can be removed. In a preferred embodiment of the invention, the nitrogen oxides which separate out in the course of acidification are fed into the nitric acid recovery of the nitration plant and are therefore not lost to the process. The chemical oxygen demand of the wastewater stream treated by the process according to the invention is reduced significantly. The use of the concentrated waste sulfuric acid does not necessarily increase the amount of process wastewater to be cleaned, as is the case when dilute acid is used.

The process according to the invention is used for workup of alkaline process wastewater from the nitration of aromatic compounds, or of a mixture W of alkaline process wastewater from the nitration and the aqueous distillate from the sulfuric acid concentration. Preference is given to using the process in the nitration of benzene, toluene, xylene, chlorobenzene and/or dichlorobenzene.

The alkaline process wastewater obtained from the one-stage or multistage scrubbing of the crude product from the nitration with aqueous alkaline solution such as sodium hydroxide solution, aqueous carbonate or hydrogencarbonate solution or aqueous ammonia solution has, depending on the base used, a pH of 7.5 to 13, preferably 8 to 10, measured at 60° C.

The aqueous distillate from the concentration of the sulfuric acid, which is also used in the case of use of the mixture, has a pH of 0.5 to 1.5, measured at 60° C., and also comprises proportions of mono- and dinitrotoluene in amounts of in each case approx. 100-250 mg/l. The mixture of alkaline process wastewater and aqueous distillate from the sulfuric acid concentration has a pH of 6 to 10 at mixing ratios of 2:1 to 3:2.

According to the invention, the alkaline process wastewater or the mixture of alkaline wastewater and the aqueous distillate from the sulfuric acid concentration is adjusted to a pH below 2, preferably of 0.1 to 1, by adding concentrated process sulfuric acid which originates from the workup of the aqueous, sulfuric acid-containing phase obtained in the nitration. The pH figures are each based on measurement at 60° C. In the acidification of the alkaline process wastewater or of the mixture, an organic phase which comprises hydroxynitroaromatics and neutral nitro species separates out. The acidified, originally alkaline process wastewater or the acidified mixture W of alkaline process wastewater and aqueous distillate from the sulfuric acid concentration is referred to, together with the organic phase which separates out, as mixture A in the context of the invention.

The concentrated sulfuric acid used for acidification has a concentration of 85 to 95% by weight, preferably of 90 to 93% by weight. In a preferred embodiment, only waste sulfuric acid obtained in the nitration is added to the acidification in step a), particular preference being given to adding all of the waste sulfuric acid obtained in the nitration in step a). The addition of the concentrated sulfuric acid is advantageously controlled via online pH measurement.

The mixing of the concentrated sulfuric acid with the alkaline process wastewater or with the mixture leads to significant evolution of gas. The gas mixture which separates out comprises nitrogen oxides, especially nitrogen monoxide and nitrogen dioxide. The gas which separates out comprises, in the case of preceding DNT scrubbing with aqueous alkali metal carbonate or alkali metal hydrogencarbonate solution, typically 70 to 98.9% by volume of carbon dioxide and 1.1 to 30% by volume of nitrous gases (nitrogen monoxide, nitrogen dioxide, dinitrogen monoxide). The gas mixture which separates out preferably comprises 80 to 98% by volume of carbon dioxide, 2 to 20% by volume of nitrous gases. When the process wastewater comprises, instead of alkali metal carbonate or alkali metal hydrogencarbonate, one or more other bases which do not form gaseous components after acidification, the gaseous phase consists essentially of nitrous gases (NOx), typically 47 to 98% nitrogen monoxide, 1 to 47% nitrogen dioxide and 1 to 6% dinitrogen monoxide.

The nitrogen oxides which separate out in the course of acidification are preferably removed and utilized in the nitric acid preparation. Particular preference is given to recycling the nitrogen oxides removed into the nitric acid recovery of the nitration plant. The gas mixture is typically fed into the absorption columns of the NOx absorption of the nitric acid recovery of the nitration plants. It is particularly advantageous when the entire gas mixture is recycled directly and without preceding removal of CO₂ and purification.

In the extraction of the mixture A obtained in step a), in step b) of the process according to the invention, an aromatic extractant is used. Suitable extractants are all aromatic compounds typically used for extractions, especially aromatic solvents. In a preferred embodiment of the invention, the aromatic starting compound used in the nitration is used in each case as the extraction solution. This means that benzene is used in the case of nitration of benzene to NB or DNB, and toluene in the case of nitration of toluene to MNT or DNT. In the case of polynitrated aromatics such as DNB or DNT, in addition to the non-nitrated aromatic, the nitroaromatic comprising one nitro group fewer, for example MNT in the case of DNT, can be used.

The alkaline process wastewater is typically obtained at a temperature of 50 to 80° C. According to the invention, the alkaline process wastewater is preferably acidified at this temperature by adding the waste sulfuric acid (step a)). The extraction is preferably performed within a temperature range of 40-80° C., but more preferably at the temperature at which the scrubbing of the crude nitroaromatic mixture with the alkaline scrubbing water is performed. Thus, it is possible to avoid separating of the neutral nitro species out of the scrubbing liquor in the course of partial cooling. The temperature in the course of extraction is preferably 60 to 70° C.

The extractant/mixture A ratio should be selected such that extraction of the neutral nitro species and of the hydroxynitroaromatics down to the desired limit or required minimum can be achieved with a minimum number of extraction stages. The weight ratio of extractant to mixture A used can be varied within the range from 1:10 to 1:2, preferably from 1:5 to 1:3. Typically, the mixture A is extracted once to five times, preferably once to three times. For a good result, the mixture A should be extracted at least twice (2 stages). For a best possible result—wastewater without mono- and dinitrotoluene and without trinitrocresols—an at least three-stage extraction should be employed.

The extraction is performed by processes for liquid/liquid extraction known to those skilled in the art. The extraction is preferably performed in countercurrent. The extraction apparatus used may, for example, be mixer/settler apparatus or stirred multistage or pulsed packed columns or sieve tray columns. However, static mixers in conjunction with suitable separating apparatus or columns without energy input can also be used to perform the extraction. In order to improve the extraction result, however, mechanical energy is preferably introduced into the system in the course of extraction, for example by stirring or pulsing. In a preferred embodiment of the invention, the extraction is performed in a pulsating packed column, a stirred cell extractor or a mixer-settler apparatus.

For the establishment of optimal mixing and separating behavior in the extraction apparatus used, particularly in the case of small ratios of extractant/mixture A, the extractant which is obtained after the phase separation and is laden with extracted neutral nitroaromatics and hydroxynitroaromatics can be circulated within each countercurrent stage, and only the freshly added amount of extractant to the corresponding envisaged ratio of extractant/mixture A is discharged and recycled into the nitration.

This means, a certain amount of fresh extractant is added to adjust an envisaged ratio of extractant/mixture A and an amount of extractant corresponding to said amounts is discharged and recycled into the nitration.

In a preferred embodiment, the extractant, after the extraction, including the extracted neutral nitroaromatics and hydroxy nitro compounds, is recycled into the nitration plant.

The aqueous phase comprises, after the extraction, typically approx. 100-500 ppm of extractant. The residues of the aromatic extractant dissolved in the aqueous phase can, in one embodiment of the invention, be removed from the aqueous phase by stripping or distillation, for example by means of steam or nitrogen stripping. The energy required for the stripping of the volatile extractants is significantly lower than that for the stripping of the nitro compounds prepared therefrom.

In a further embodiment of the invention, the water which still comprises extractant and is obtained in the stripping, together with the extractant removed in the course of stripping, is added again to the alkaline scrubbing water before the extraction.

The process according to the invention can be performed batchwise or continuously. Preference is given in accordance with the invention to performing the process continuously.

The invention is illustrated hereinafter by examples.

Determination of the TOC:

TOC=total organic carbon, measured to DIN EN 1484 (1997)/AQS P-14 (1995):

Area of Application

Determination of the mass concentration of organic carbon in drinking water, groundwater, surface water and wastewater. It is possible to determine the total carbon TC and the total organic carbon TOC. The inorganic carbon TIC can be determined by subtracting the TOC from the TC.

Measurement Principle

In the “Dimatoc 100” with outgassing system, the inorganically bound carbon (carbonates, hydrogencarbonates, etc) is driven out by addition of hydrochloric acid, by means of nitrogen. Subsequently, the sample is metered into the quartz reactor. Here, the catalytic oxidation of the organically bound carbon takes place at 850° C. The carbon dioxide formed is detected in the IR detector.

In the two-channel Dimatoc 100 system (2 reactors with one IR detector each), a difference measurement is also possible: TOC=TC−TIC

With the aid of a cellulose suspension, the particle mobility is examined.

In all examples, the alkaline process wastewater originates from the scrubbing of the organic phase from the nitration with aqueous sodium carbonate solution.

### EXAMPLE 1

### Alkaline DNT Wastewater

Toluene extraction in a pulsating packed column with an extraction ratio of toluene to wastewater=1:3. The extraction was performed with alkaline process wastewater from the nitration of toluene without acidification, with acidification to 4≦pH ≦4.8 and with acidification to pH<2 (according to the invention).

220 l/h of the alkaline wastewater (approx. 65° C., pH=8.5) were stirred in a 50 liter stirred vessel and optionally acidified with 93% waste sulfuric acid which was metered separately into the stirred vessel by means of a pump. Between the stirred vessel and extraction column was an online pH meter, and the offgas of the mixture of CO₂ and NOx which forms was fed via a line to a compressor and finally an absorber column.

The possibly acidic mixture passed continuously with a throughput of 220 l/h from the top into the pulsating packed column (PPC). The toluene was conveyed from the bottom upward in countercurrent with a throughput of 73 l/h. The light toluene solvent took up the organic constituents and the toluene extract thus formed was then removed by means of a separator and recycled into the nitration.

The PPC used with a diameter of DN 80 and a length of 2400 mm consisted of 4 extraction stages. The column velocity was 61.32 m³/m² h at a throughput of 293 l/h.

The analysis results of the starting material and of the wastewaters extracted at different pH values are shown in Table 1.

TABLE 1

| | | | Extracted | Extracted |
|---|---|---|---|---|
| | DNT | | wastewater | wastewater |
| | wastewater | Extracted | (acidic, not | (acidic, |
| | starting | wastewater | according to | according to |
| | values | (alkaline) | the invention) | the invention) |
| pH | 8.5 | 8.3 | 4.8 | 1.0 |
| DNT¹ in ppm | 804 | 14 | 12 | 1 |
| MNT² in ppm | 6 | <1 | <1 | <1 |
| TNC³ in ppm | 258 | 236 | 258 | 8 |
| Carbonate in % | 1.66 | 1.23 | — | — |
| CO₂ in % | — | — | — | 63.1 |
| NOx in % | — | — | — | 2.2 |
| TOC⁴ in mg/l | 1633 | 985 | 869 | 660 |

¹Sum of 2,4-/2,6-/3,4-dinitrotoluene
²Sum of 2-/3-/4-mononitrotoluene
³Sum of 2,4,6-/3,4,6-trinitrocresol
⁴Total organic carbon in mg/l

### EXAMPLE 2

### Toluene Extraction in a Stirred Cell Extractor

Extraction ratio of toluene to wastewater=1:3. The extraction was performed with alkaline wastewater from the nitration without acidification, with acidification to 4≦pH≦4.8 and with acidification to pH<2 (according to the invention).

120 l/h of the alkaline wastewater (approx. 65° C.) were stirred in a 50 liter stirred vessel and optionally acidified to a pH of 0.5 with the 93% waste sulfuric acid which was metered separately into the stirred vessel by means of a pump. Between the stirred vessel and extraction unit was an online pH meter, and the offgas of the mixture of CO₂ and NOx which forms as a result of the acidification was fed between stirred vessel and extraction unit via a line to a compressor and finally to an absorber column, in order that the offgases do not adversely affect the extraction in the stirred cell extractor (SCE). The speed of the SCE was 200 rpm. The acidic wastewater passed continuously with a throughput of 120 l/h from the top into the SCE. The toluene was conveyed from the bottom upward in countercurrent with a throughput of 40 l/h. The light toluene solvent took up the organic constituents, and the toluene extract thus formed was then removed at the top by means of a separator and recycled into the nitration.

The SCE used, with a diameter of DN 100 and a length of 1000 mm, consisted of 15 extraction stages. The space velocity of the SCE was 20.37 m³/m² h at a throughput of 160 l/h.

The analysis results are shown in Table 2.

TABLE 2

| | | | Extracted | Extracted |
|---|---|---|---|---|
| | | | wastewater | wastewater |
| | DNT | | (acidic, not | (acidic, |
| | wastewater | Extracted | according | according |
| | starting | wastewater | to the | to the |
| | values | (alkaline) | invention) | invention) |
| pH | 8.2 | 8.0 | 4.7 | 0.1 |
| DNT¹ in ppm | 636 | 7 | 10 | <1 |
| MNT² in ppm | <1 | 1 | <1 | <1 |
| TNC⁵ in ppm | 481 | 555 | 392 | 12 |
| NBA⁶ in ppm | 720 | 796 | 633 | 441 |
| N-Nitrosomorpholine | — | — | 45 | 2 |
| Carbonate in % | 1.99 | 1.34 | — | — |
| CO₂ in % | — | — | 52.0 | 75.6 |
| TOC⁴ in mg/l | 1609 | 972 | 852 | 598 |

EK09-0418PC - as originally filed -
⁵Sum of trinitrocresols (2,4,6-/3,4,6-/2,5,6-/4,5,6-TNC)
⁶Content of 2,4-dinitrobenzoic acid + 4-nitrobenzoic acid

### EXAMPLE 3

### Toluene Extraction in a Pulsating Packed Column

Extraction ratio of toluene to wastewater=1:3. The extraction was performed with alkaline process wastewater from the nitration without acidification, with acidification to 4≦pH≦4.8 and with acidification to pH<2 (according to the invention).

A mixture of alkaline DNT wastewater and SAC wastewater (aqueous distillate from the sulfuric acid concentration) in a mixing ratio of 3:2 with a pH of 7.2 was prepared in a 50 liter stirred vessel and optionally acidified with 93% waste sulfuric acid, which was metered separately into the stirred vessel by means of a pump. Between the stirred vessel and PPC was an online pH meter, and the offgas of the mixture of CO₂ and NOx which forms was fed via a line to a compressor and finally to an absorber column since, among other reasons, the evolution of gas during the delivery adversely affects plant safety and the throughput rate of the PPC.

The acidic wastewater passed continuously with a throughput of 270 l/h into the PPC from the top. The toluene was conveyed from the bottom upward in countercurrent with a throughput of 90 l/h. The light toluene solvent took up the organic constituents, and the toluene extract thus formed was then removed at the top by means of a separator and recycled into the nitration.

The PPC used with a diameter of DN 80 and a length of 2400 mm consisted of 4 extraction stages. The column velocity here was 75.34 m³/m² h at a throughput of 360 l/h.

The analysis results are shown in Table 3.

TABLE 3

| | | | Extracted | Extracted |
|---|---|---|---|---|
| | Wastewater | | wastewater | wastewater |
| | mixture | Extracted | (acidic, not | (acidic, |
| | starting | wastewater | according to | according to |
| | values | (alkaline) | the invention) | the invention) |
| pH | 7.5 | 7.0 | 4.1 | 0.9 |
| DNT¹ in ppm | 830 | 21 | 11 | 3 |
| MNT² in ppm | 188 | <1 | <1 | <1 |
| TNC³ in ppm | 112 | 84 | 45 | <1 |
| Carbonate in % | 0.68 | 0.50 | — | — |
| CO₂ in % | — | — | — | 38.9 |
| NOx in % | — | — | — | 2.0 |
| TOC⁴ in mg/l | 1182 | 724 | 603 | 579 |

### EXAMPLE 4

### Alkaline DNT Wastewater+SAC Wastewater

Toluene extraction in a stirred cell extractor with an extraction ratio of toluene to wastewater=1:3. The extraction was performed with alkaline process wastewater from the nitration without acidification, with acidification to 4≦pH≦4.8 and with acidification to pH<2 (according to the invention).

72 l/h of the alkaline wastewater (approx. 65° C.) were mixed with 48 l/h of the aqueous distillate from the sulfuric acid concentration (mixing ratio 3:2) in a 50 liter stirred vessel, and optionally acidified with 93% waste sulfuric acid, which was metered separately into the stirred vessel by means of a pump.

Between the stirred vessel and SCE was an online pH meter, and the offgas of the mixture of CO₂ and NOx which forms as a result of the acidification is fed between stirred vessel and SCE via a line to a compressor and finally to an absorber column, in order that the offgases do not adversely affect the extraction in the stirred cell extractor (SCE). The speed of the SCE was 200 rpm. The acidic wastewater passes continuously with a throughput of 120 l/h into the SCE from the top. The toluene was conveyed from the bottom upward in countercurrent with a throughput of 40 l/h. The light toluene solvent took up the organic constituents, and the toluene extract thus formed was then removed at the top by means of a separator and recycled into the nitration.

The SCE used, with a diameter of DN 100 and a length of 1000 mm, consisted of 15 extraction stages. The space velocity of the SCE was 20.37 m³/m² h at a throughput of 160 l/h.

The analysis results are shown in Table 4.

TABLE 4

| | | | Extracted | Extracted |
|---|---|---|---|---|
| | | | wastewater | wastewater |
| | Wastewater | | (acidic, not | (acidic, |
| | mixture | Extracted | according | according |
| | starting | wastewater | to the | to the |
| | values | (alkaline) | invention) | invention) |
| pH | 7.4 | 7.2 | 4.2 | 0.1 |
| DNT¹ in ppm | 533 | 10 | 10 | <1 |
| MNT² in ppm | 325 | <1 | <1 | <1 |
| TNC⁵ in ppm | 332 | 241 | 212 | <1 |
| NBS⁶ in ppm | 503 | 376 | 359 | 164 |
| N-Nitrosomorpholine | — | — | 32 | 1 |
| Carbonate in % | 1.60 | 1.44 | — | — |
| CO₂ in % | — | — | — | 57.0 |
| TOC⁴ in mg/l | 1682 | 800 | 745 | 437 |

### EXAMPLE 5

Toluene extraction without preceding acidification of the alkaline DNT wastewater in a pulsating DN 80 packed column at different extraction ratios of toluene to wastewater at maximum wastewater throughput of 220 l/h (not according to the invention). The analysis results are shown in Table 5. The method was the same as described in Examples 1 and 3.

TABLE 5

| | DNT | Extracted | Extracted | Extracted |
|---|---|---|---|---|
| | wastewater | wastewater | wastewater | wastewater |
| | starting values | (alkaline) | (alkaline) | (alkaline) |
| Weight ratio of | | 1:3 | 1:4 | 1:5 |
| toluene:wastewater | | | | |
| pH | 8.5 | 8.3 | 8.3 | 8.4 |
| DNT¹ in ppm | 804 | 14 | 52 | 89 |
| MNT² in ppm | 6 | <1 | 1 | 1 |
| TNC³ in ppm | 258 | 236 | 272 | 289 |
| Carbonate in % | 1.66 | 1.23 | 1.41 | 1.29 |
| TOC⁴ in mg/l | 1633 | 985 | 1096 | 1165 |

The phase separation and extraction result deteriorate with increasing excess of wastewater.

### EXAMPLE 6

Toluene extraction with acidification of the alkaline DNT wastewater to pH≦2, according to the invention in a pulsed DN 80 packed column at different extraction ratios of toluene to wastewater at maximum wastewater throughput of 220 l/h. The results are shown in Table 6.

TABLE 6

| | | Extracted | Extracted | Extracted |
|---|---|---|---|---|
| | | wastewater | wastewater | wastewater |
| | DNT | (acidic, | (acidic, | (acidic, |
| | wastewater | according | according | according |
| | starting | to the | to the | to the |
| | values | invention) | invention) | invention) |
| Weight ratio of | | 1:3 | 1:4 | 1:5 |
| toluene:wastewater | | | | |
| pH | 8.5 | 1.0 | 1.2 | 1.2 |
| DNT¹ in ppm | 804 | 1 | 19 | 38 |
| MNT² in ppm | 6 | <1 | 1 | 1 |
| TNC³ in ppm | 258 | 8 | 24 | 30 |
| TOC⁴ in mg/l | 1633 | 660 | 723 | 753 |

The phase separation and the extraction result deteriorate with increasing excess of wastewater, but the end result with regard to the extraction, for example, of the TNCs is nevertheless significantly better compared to the extraction of the unacidified wastewater or wastewater acidified only to 4≦pH≦4.8 (see Example 4).

### EXAMPLE 7

### Alkaline DNT Wastewater

Toluene extraction without pulsator for DN 80 packed column

TABLE 7

| | DNT | Extracted | Extracted wastewater |
|---|---|---|---|
| | wastewater | wastewater | (acidic, according |
| | starting values | (alkaline) | to the invention) |
| Weight ratio of | | 1:4 | 1:4 |
| toluene:wastewater | | | |
| pH | 8.5 | 8.3 | 1.5 |
| DNT¹ in ppm | 757 | 149 | 96 |
| MNT² in ppm | 4 | 3 | 1 |
| TNC³ in ppm | 116 | 121 | 42 |
| TOC⁴ in mg/l | 1516 | 1132 | 954 |

As a result of the omission of the pulsator, barely any mechanical energy is introduced and a lower level of nitrotoluenes and nitrocresols is extracted, as evident in comparison with Examples 5 and 6 (in each case for the ratio of toluene to wastewater of 1:4).

### EXAMPLE 8

### Alkaline DNT Wastewater

Toluene extraction in a mixer-settler apparatus 2 kg of alkaline DNT wastewater were acidified to a pH of 0.5 with 110 g of 93% waste sulfuric acid and extracted in a mixer-settler apparatus with 1 kg of toluene in a ratio of 1:2 (toluene:wastewater). Here too, the offgas formed by acidification (NOx+CO₂), after the stirring process, was sent to an offgas processing step for preparation of nitric acid.

TABLE 8

| | | Extracted | Extracted |
|---|---|---|---|
| | DNT | wastewater (acidic, | wastewater (acidic, |
| | wastewater | according to the | according to the |
| | starting | invention) | invention) |
| | values | 3 extraction stages | 6 extraction stages |
| Weight ratio of | | 1:2 | 1:2 |
| toluene:wastewater | | | |
| pH | 0.5 | 0.5 | 0.5 |
| DNT¹ in ppm | 357 | <1 | <1 |
| MNT² in ppm | 1 | <1 | <1 |
| TNC³ in ppm | 260 | <1 | <1 |
| NBA⁶ in ppm | 637 | 176 | 51 |
| TOC⁴ in mg/l | 1390 | — | 640 |

The mixer-settler experiment showed that, in the case of an increased proportion of extractant, the TNCs can be lowered to less than 1 ppm without any problem, and even the nitrobenzoic acids which are otherwise difficult to extract (very low partition coefficients) could be lowered to only 8% compared to the starting value after 6 extraction stages.

### EXAMPLE 9

Mixture of alkaline DNT wastewater, acidic DNT wastewater and aqueous distillate from the sulfuric acid concentration in a ratio of 2:1:3, pH=4.8 Toluene extraction with a mixer-settler apparatus

TABLE 9

| | | Extracted | Extracted |
|---|---|---|---|
| | DNT | wastewater (acidic, | wastewater (acidic, |
| | wastewater | not according to | not according to |
| | starting | the invention) | the invention) |
| | values | 1 extraction stage | 4 extraction stages |
| Weight ratio of | | 1:10 | 1:10 |
| toluene:wastewater | | | |
| pH | 4.8 | 4.8 | 4.8 |
| DNT¹ in ppm | 407 | 10 | 1 |
| MNT² in ppm | 110 | 3 | 1 |
| TNC³ in ppm | 78 | 84 | 72 |
| NBS⁶ in ppm | 185 | 166 | 222 |
| TOC⁴ in mg/l | 1050 | — | 690 |

A wastewater mixture with a pH of 4.8 leads only to the extraction of MNT and DNT. The nitrocresols and nitrobenzoic acids are not extracted, i.e. the total amount of nitrocresols and nitrobenzoic acids is sent with the wastewater to the ozonization/thermolysis/biological workup.

### CONCLUSION

In the case of extremely acidified wastewater and in the case of optimized extraction ratios and technological process conditions, it is possible to completely extract MNT, DNT and NC, and the extraction of the nitrobenzoic acids can also be reduced to a minimum.

### EXAMPLE 10

### Reduction in the Nitrite Content

An alkaline process wastewater from the DNT preparation with a pH of 8.5 was acidified to pH=0.5 with 93% concentrated sulfuric acid and extracted with a mixer-settler apparatus according to Example 8 having 3 extraction stages with toluene. The nitrite concentrations of the alkaline process water, of the acidified mixture and of the toluene-extracted wastewater are shown in Table 10

TABLE 10

| | DNT | Acidified | |
|---|---|---|---|
| | wastewater | wastewater | Extracted DNT |
| | pH = 8.5 | pH = 0.5 | wastewater (stage 3) |
| Nitrite content [mg/l] | 3843 | 23 | <1 |

1. A process for working up alkaline process wastewater, the process comprising:
a) acidifying alkaline process wastewater from a nitration of at least one aromatic compound, or a mixture W of the alkaline process wastewater and an aqueous distillate of a sulfuric acid concentration, by adding concentrated sulfuric acid originating from a workup of an aqueous, sulfuric acid-containg phase obtained by nitration to a pH below 2, to form a mixture A consisting of an organic phase which separates out and an acidic aqueous phase; and
b) extracting the mixture A with an aromatic extractant.

2. The process according to claim 1, wherein the concentrated sulfuric acid has a concentration of 85 to 95% by weight.

3. The process according to claim 1, wherein all of the concentrated waste sulfuric acid obtained from the workup of the nitration is added in step a).

4. The process according to claim 1, wherein the aromatic extractant is the at least one aromatic compound, which is a starting compound in the nitration.

5. The process according to claim 4, wherein the at least one aromatic compound is benzene, toluene, xylene, chlorobenzene, dichlorobenzene, or mixture thereof.

6. The process according to claim 1, wherein a weight ratio of aromatic extractant to the mixture A is 1:10 to 1:2.

7. The process according to claim 1, wherein the extracting b) occurs at temperatures of 20 to 80° C.

8. The process according to claim 1 any of claims 1, wherein a gas mixture comprising a nitrogen oxide oxide separates out in the acidifying a) and is removed before the extracting b).

9. The process according to claim 8, wherein the gas mixture removed before the extracting b) is utilized in nitric acid preparation.

10. The process according to claim 8, wherein the gas mixture is removed before the extracting b) is recycled into a nitric acid recovery in the nitration.

11. The process according to claim 1, wherein the aromatic extractant, comprising, extracted nitroaromatics and hydroxy nitro compounds, is recycled into the nitration after the extracting b).

12. The process according to claim 1, wherein the extracting b) occurs in countercurrent.

13. The process according to claim 1, wherein the extracting b) occurs with input of mechanical energy.

14. The process according to claim 1, wherein the extracting b) occurs in a pulsed packed column, a stirred cell extractor or a mixer-settler apparatus.

15. The process according to claim 1, wherein at least one residues of the aromatic extractant dissolved in the acidic aqueous phase is removed by stripping or distillation.

16. The process of claim 1, which is suitable for working up alkaline process wastewater from a nitration of aromatic compounds to mono-, di- and trinitroaromatics with a pH of 7.5 to 13, or a mixture with a pH of 6 to 10 of alkaline process wastewater and the aqueous distillate of the sulfuric acid concentration.

17. The process according to claim 1, wherein the concentrated sulfuric acid has a concentration of 90 to 93% by weight.

18. The process according to claim 1, wherein a weight ratio of aromatic extractant to the mixture A is 1:5 to 1:3.

19. The process according to claim 1, wherein the extracting b) occurs at temperatures of 60 to 70° C.
